(19) United States
(12) Patent Application Publication
(10) Pub. No.: US 2008/0019035 A1
(43) Pub. Date: Jan. 24, 2008

(54) TAPE CARTRIDGE RECORDING/PLAYBACK APPARATUS

(76) Inventor: Tomoaki Sakaguchi, Kanagawa (JP)

Correspondence Address: LADAS & PARRY LLP, 224 SOUTH MICHIGAN AVENUE, SUITE 1600, CHICAGO, IL, 60604, US

(21) Appl. No.: 11/750,395

(22) Filed: May 18, 2007

(30) Foreign Application Priority Data
Jul. 20, 2006 (JP) 2006-198417

(51) Int. Cl. G11B 15/00

(52) U.S. Cl. 360/90

(57) ABSTRACT

A tape cartridge recording/playback apparatus that receives a tape cartridge into an interior portion of the apparatus is disclosed. The apparatus includes a tape cartridge misleading prevention key that prevents misloading of the tape cartridge. The tape cartridge misleading key is rotatably mounted in the interior portion of the apparatus and includes (i) a protruding portion that blocks an inserting direction front end face of the tape cartridge when the tape cartridge is improperly inserted and inhibits the tape cartridge from being inserted further, the protruding portion being in a first plane, and (ii) a block portion that is contacted by the tape cartridge when the tape cartridge is properly inserted, the block portion moving the protruding portion to a position where the protruding portion does not block insertion of the tape cartridge, the block portion being in a second plane that is different than the first plane.

### BACKGROUND OF THE INVENTION

1. Field of the Invention

The present invention relates generally to a tape cartridge recording/playback apparatus and particularly to a tape cartridge misloading prevention mechanism that is arranged at a mail slot for preventing the misleading of a tape cartridge.

2. Description of the Related Art

A typical tape cartridge autoloader includes a tape cartridge picker in the center, a mail slot at the front side, a read/write tape drive at the rear side, and tape cartridge transport magazines disposed one at each lateral side.

The tape cartridge picker is configured to transport a tape cartridge between the mail slot, the tape drive, and the tape cartridge transport magazines. A tape cartridge misleading prevention mechanism for preventing the misleading of the tape cartridge is arranged at the mail slot.

FIG. 23 is a diagram showing a configuration of a tape cartridge misleading prevention mechanism according to the prior art. The illustrated tape cartridge misleading prevention mechanism is configured to prevent the misloading of a LTO (Linear Tape Open) tape cartridge (brand name). Pillars 2 and 3 are arranged at the lateral sides of an loading passage (mail slot) 1 of a LTO tape cartridge 10, and a misleading prevention key 4 that is configured to rotate around an axis 5 is arranged at the pillar 2 on the X2 side of the loading passage 1. An end portion 4a of the tape cartridge misloading prevention key 4 is arranged to protrude toward the inner side of the loading passage 1.

The LTO tape cartridge 10 has an outer configuration as is shown in FIG. 25A. As is shown in this drawing and in FIG. 2, a magnetic tape 11 is wound around a single reel 12 to be accommodated inside a cartridge main frame having a thickness of T1, and the magnetic tape 11 is arranged to be drawn out from the rear side. The LTO tape cartridge 10 includes a front face 13, a rear face 14, and side faces 15 and 16. The side face 15 has a groove 15a for realizing engagement with a cartridge pin (not shown) of a tape cartridge picker 102 as is described in detail below. A triangular recessed step portion 17 is arranged at a corner portion of the upper face of the LTO tape cartridge 10 at which the rear face 14 and the side face 15 meet. The triangular recessed step portion 17 includes a wall portion 17a at its edge that extends in a direction slanted with respect to the Y1-Y2 line. It is noted that the height of the upper surface of the triangular recessed step portion 17 with respect to the bottom face of the LTO tape cartridge 10 is denoted as h1.

The end portion 4a of the misloading prevention key 4 is arranged at a height corresponding to the height h1 of the triangular recessed step portion 17 of the LTO tape cartridge 10 inserted into the mail slot 1.

As is shown in FIG. 24A, when the LTO tape cartridge 10 is loaded in a proper position, the triangular recessed step portion 17 fits underneath the misleading prevention key 4 so that the inner wall portion 17a of the triangular recessed step portion 17 comes into contact with the end portion 4a of the misleading prevention key 4 to rotate the misleading prevention key 4 in the counterclockwise direction and push the misloading prevention key 4 toward the X2 side of the LTO tape cartridge loading passage 1. The LTO tape cartridge 10 is loaded to reach a position indicated by the two-dotted lines in FIG. 24A.

When the LTO tape cartridge 10 is loaded in a position other than the proper position; for example, when the LTO tape cartridge 10 is loaded upside down as is shown in FIG. 24B, the face 14 corresponding to the inserting direction front end of the LTO tape cartridge 10 comes into contact with the end portion 4a of the misleading prevention key 4 so that the LTO tape cartridge 10 is prevented from being inserted further.

There are currently two types of tape cartridges on the market as tape cartridges adapted for in the tape cartridge autoloader as is described above. The LTO tape cartridge as is described above corresponds to one of the two types, and a DLT (Digital Linear Tape) tape cartridge (brand name) corresponds to the other type. Accordingly, a tape cartridge auto loader manufacturer has to manufacture a LTO tape cartridge autoloader adapted for the LTO tape cartridge and a DLT tape cartridge autoloader adapted for the DLT tape cartridge.

FIG. 25B is a diagram showing the outer configuration of the DLT tape cartridge 10A, which includes a front face 13A, a rear face 14A, and side faces 15A and 16A. As is shown in this drawing and in FIG. 15, the DLT tape cartridge 10A includes a recessed portion 18 arranged at the side face 16A instead of the triangular recessed step portion 17 of the LTO tape cartridge 10, and the DLT tape cartridge 10A also includes a slit 19 connected to the recessed portion 18 that is arranged at a corner portion defined by the rear face 14A and the side face 16A, the slit 19 being positioned at a height that is slightly lower than the middle height position with respect to the thickness direction of the DLT tape cartridge 10A. The side face 15A includes a groove 15Aa. The height from the bottom face of the DLT tape cartridge 10A to the slit 19 is denoted as h2. It is noted that the height h2 is not equal to the height h1 shown in FIG. 25B (i.e., h2<h1). The recessed portion 18 includes an edge portion 18a at the Z2 side and an edge portion 18b at the Y2 side.

In a case where the DLT tape cartridge 10A is loaded into the tape cartridge autoloader with the tape cartridge misleading prevention mechanism as is shown in FIG. 23, the face at the inserting direction front end of the DLT tape cartridge 10A comes into contact with the end portion 14a of the misleading prevention key 4 so that the DLT tape cartridge 10A is prevented from being inserted further.

As can be appreciated, a different tape cartridge misleading prevention mechanism has to be designed for the DLT tape cartridge autoloader.

The misleading prevention mechanisms for the DLT tape cartridge and the LTO tape cartridge are preferably designed to have as many common features as possible in order to reduce manufacturing costs.

### SUMMARY OF THE INVENTION

Accordingly, embodiments of the present invention solve one or more of the above problems.

In one embodiment of the present invention, a tape cartridge recording/playback apparatus is provided that includes:

an inlet through which a tape cartridge is passed; and

an interior portion into which the tape cartridge is inserted, the interior portion being configured to accommodate a plurality of the tape cartridges and including a tape cartridge misloading prevention key for preventing misleading of the tape cartridge, the tape cartridge misleading key being rotatably mounted at a location close to the inlet; wherein

the tape cartridge misleading prevention key includes a protruding portion that is configured to block an inserting direction front end face of the tape cartridge when the tape cartridge is improperly inserted and prevent the tape cartridge from being inserted further, and a block portion that is configured to be pushed by the tape cartridge when the tape cartridge is properly inserted and displace the protruding portion to a position where the protruding portion does not block insertion of the tape cartridge.

In another embodiment of the present invention, a tape cartridge recording/playback apparatus that receives a tape cartridge into an interior portion of the apparatus is provided, the apparatus including:

a tape cartridge misleading prevention key that prevents misleading of the tape cartridge, the tape cartridge misleading key being rotatably mounted in the interior portion, the tape cartridge misleading prevention key including (i) a protruding portion that blocks an inserting direction front end face of the tape cartridge when the tape cartridge is improperly inserted and inhibits the tape cartridge from being inserted further, the protruding portion being in a first plane, and (ii) a block portion that is contacted by the tape cartridge when the tape cartridge is properly inserted, the block portion moving the protruding portion to a position where the protruding portion does not block insertion of the tape cartridge, the block portion being in a second plane that is different than the first plane.

In another embodiment of the present invention a tape cartridge recording/playback apparatus that receives a tape cartridge into an interior portion of the apparatus is provided, the apparatus including:

a tape cartridge misleading prevention key that prevents misleading of the tape cartridge, the tape cartridge misleading key being rotatably mounted in the interior portion, the tape cartridge misleading prevention key including (i) a protruding portion that blocks an inserting direction front end face of the tape cartridge when the tape cartridge is improperly inserted and inhibits the tape cartridge from being inserted further, and (ii) a block portion that is disposed at a different height from the protruding portion, that block portion being contacted by the tape cartridge when the tape cartridge is properly inserted, the block portion moving the protruding portion to a position where the protruding portion does not block insertion of the tape cartridge.

According to one aspect of the present invention, by configuring the tape cartridge misleading prevention key to include a protruding portion as well as a block portion, misleading of a tape cartridge may be prevented while a tape cartridge that is properly inserted may pass where the tape cartridge misleading prevention key is located without being blocked by the protruding portion of the tape cartridge misloading prevention key.

### BRIEF DESCRIPTION OF THE DRAWINGS

FIG. 1 is a diagram illustrating prevention against misleading a LTO tape cartridge and a DLT tape cartridge in a LTO tape cartridge autoloader according to a first embodiment of the present invention and a DLT tape cartridge autoloader according to a second embodiment of the present invention;

FIG. 2 is a perspective view of the LTO tape cartridge autoloader according to the first embodiment of the present invention with its cover removed;

FIG. 3 is a side view of the interior of a tape cartridge transporting magazine of the LTO tape cartridge autoloader of FIG. 1 viewed from the X1 side;

FIG. 4 is a diagram illustrating operations of a tape cartridge picker;

FIG. 5 is a perspective view of a main module;

FIGS. 6A and 6B are diagrams showing the main module;

FIG. 7 is an exploded perspective view of the main module;

FIG. 8 is a perspective view of the main module viewed from the Y1 side;

FIG. 9 is a perspective view of a misleading prevention key for the LTO tape cartridge autoloader;

FIG. 10 is an enlarged view of a tape cartridge misloading prevention mechanism;

FIGS. 11A and 11B are diagrams showing the misleading prevention key for the LTO tape cartridge autoloader, the LTO tape cartridge, and a mail slot;

FIGS. 12A1-12C2 are diagrams illustrating operations of the misleading prevention key for the LTO tape cartridge autoloader in a case where the LTO tape cartridge is inserted in a proper position;

FIGS. 13A1-13C3 are diagrams illustrating operations of the misloading prevention key for the LTO tape cartridge autoloader continued from FIGS. 12A1-12C2;

FIGS. 14A-14E are diagrams illustrating operations of the misleading prevention key for the LTO tape cartridge autoloader for preventing the misleading of a tape cartridge;

FIG. 15 is a perspective view of the DLT tape cartridge according to the second embodiment of the present invention with its cover removed;

FIG. 16 is an enlarged view of a tape cartridge misloading prevention mechanism for the DLT tape cartridge autoloader;

FIG. 17 is a perspective view of a misleading prevention key for the DLT tape cartridge autoloader;

FIGS. 18A and 18B are diagrams showing the misleading prevention key for the DLT tape cartridge autoloader, the DLT tape cartridge, and a mail slot;

FIGS. 19A1-19C2 are diagrams illustrating operations of the misleading prevention key for the DLT tape cartridge autoloader in a case where the DLT tape cartridge is inserted in a proper position;

FIGS. 20A1-20C3 are diagrams illustrating operations of the misleading prevention key for the DLT tape cartridge autoloader continued from FIGS. 19A1-19C2;

FIGS. 21A-21E are diagrams illustrating operations of the misleading prevention key for the DLT tape cartridge autoloader for preventing the misleading of a tape cartridge; and

FIGS. 22A and 22B are diagrams showing mold apparatuses for molding the misleading prevention key for the LTO tape cartridge autoloader and the misleading prevention key for the DLT tape cartridge autoloader.

FIG. 23 is a diagram showing a configuration of a tape cartridge misleading prevention mechanism according to the prior art;

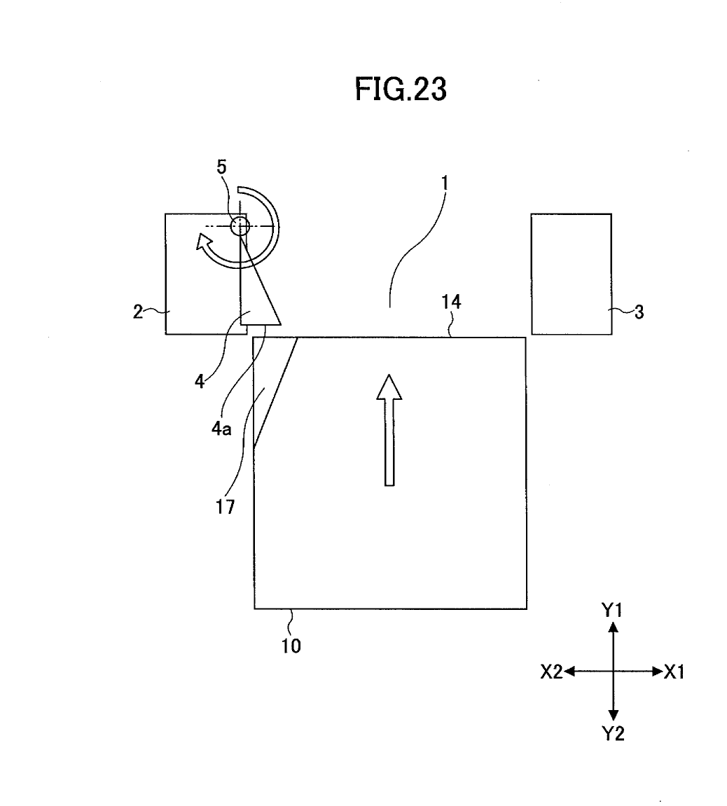

FIGS. 24A and 24B are diagrams illustrating operations of the prior art tape cartridge misleading prevention mechanism of FIG. 23 in exemplary cases of loading a tape cartridge; and

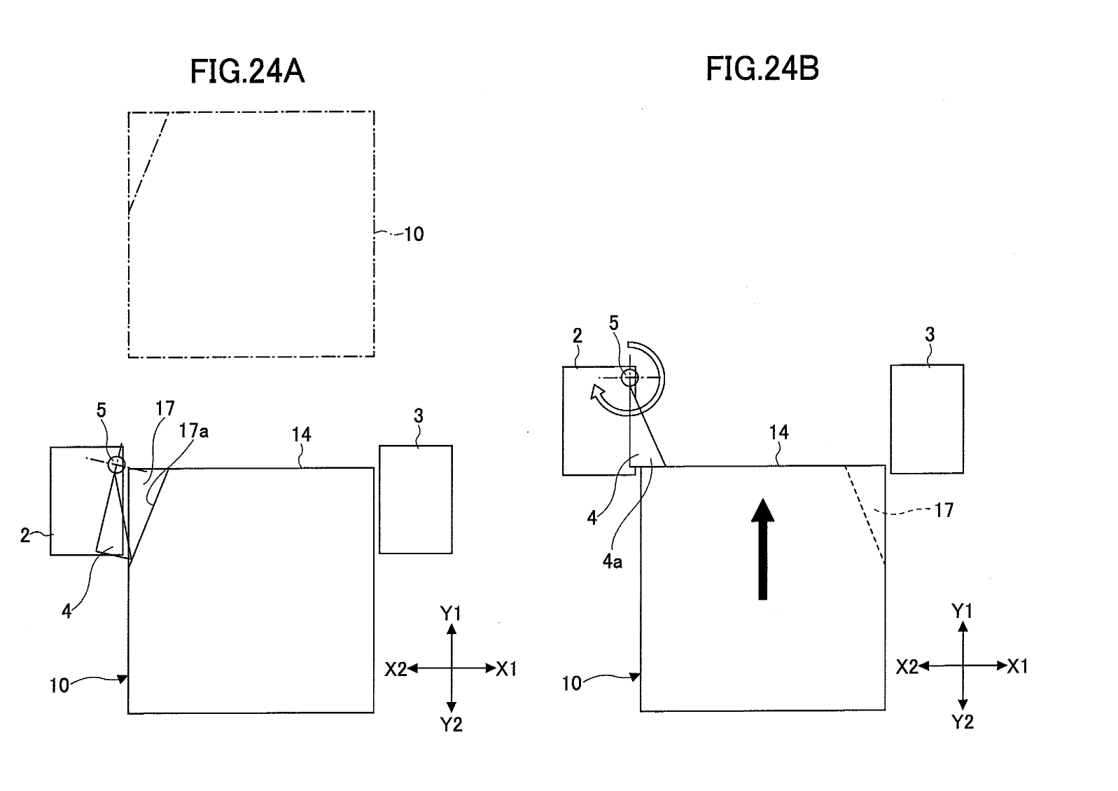

FIGS. 25A and 25B are diagrams showing prior art configurations of a LTO tape cartridge and a DLT tape cartridge, respectively.

### DETAILED DESCRIPTION OF THE PREFERRED EMBODIMENTS

In the following, preferred embodiments of the present invention are described with reference to the accompanying drawings.

Specifically, descriptions of preferred embodiments of the present invention include the following:

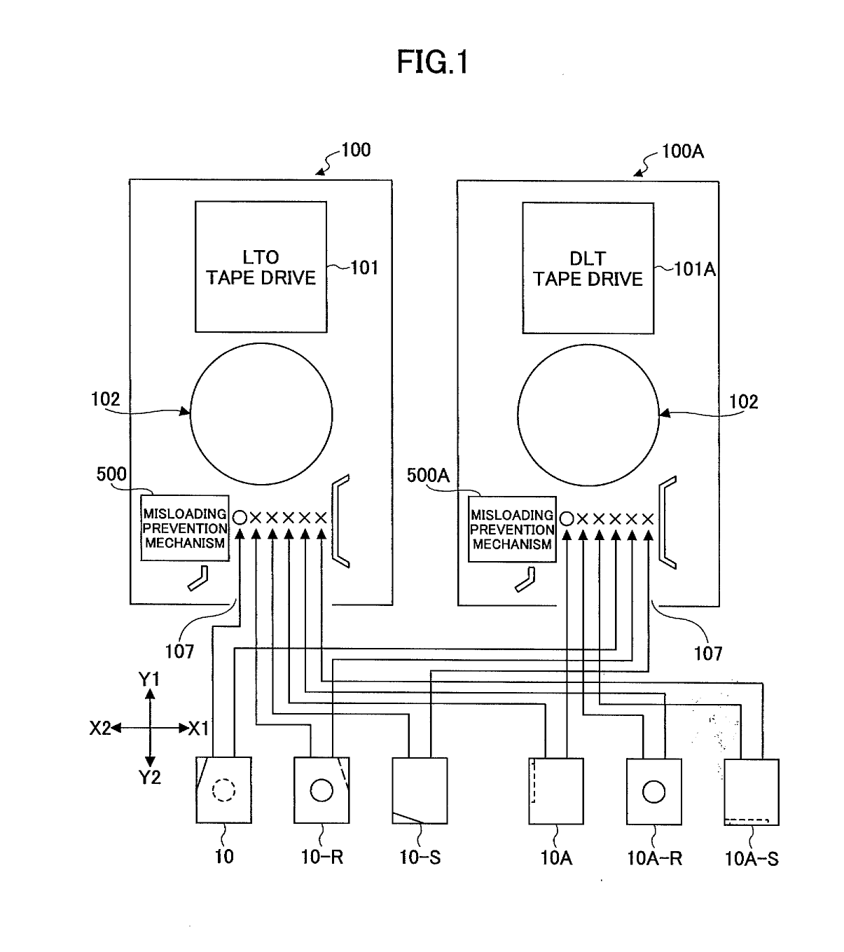

1. LTO Tape Cartridge 10 and DLT Tape Cartridge 10A Misloading Prevention in LTO Tape Cartridge Autoloader 100 and DLT Tape Cartridge Autoloader 100A (FIG. 1)

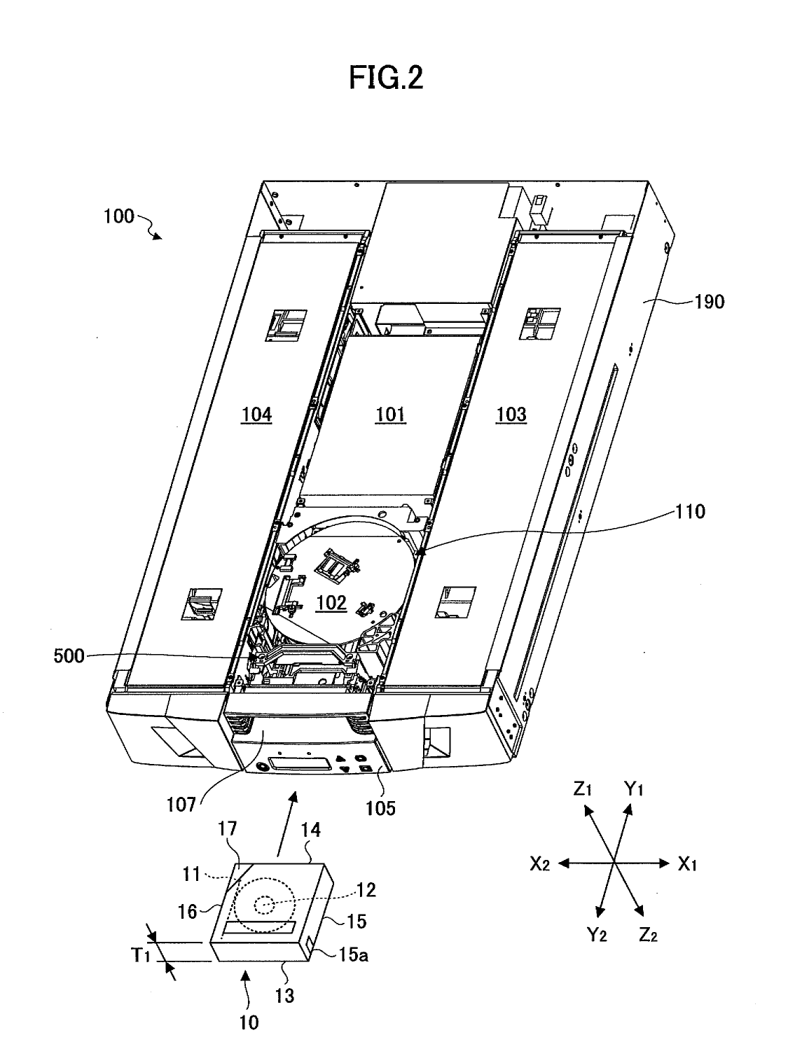

2. Configuration and Operations of LTO Tape Cartridge Autoloader 100 (FIGS. 2, 3, and 4)

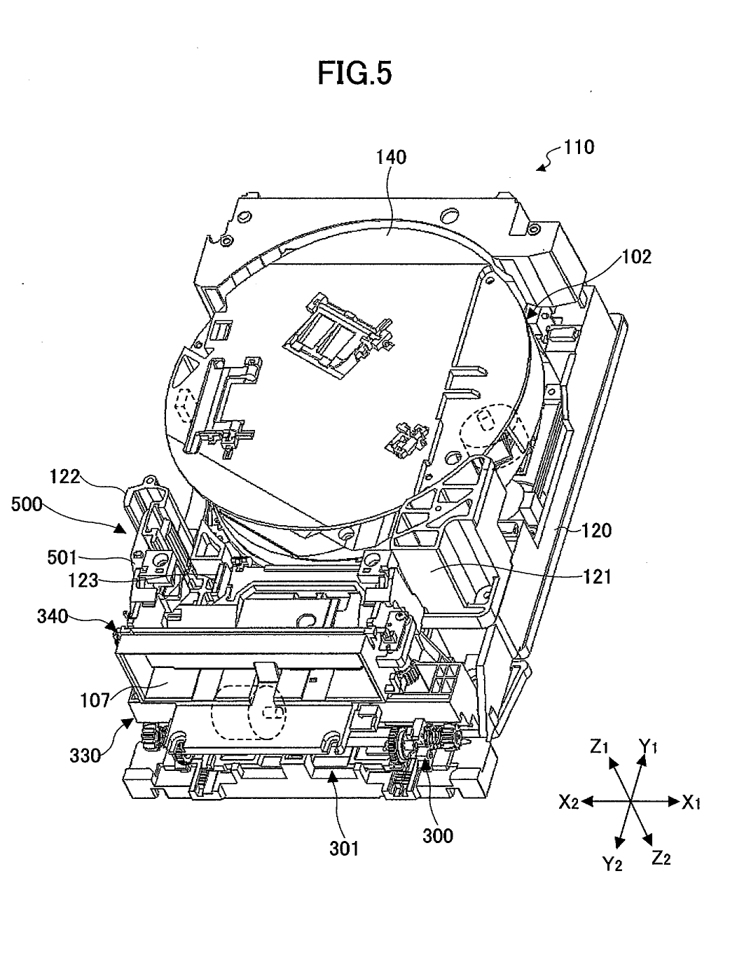

3. Configuration of Main Module 110 (FIGS. 5, 6, 7, and 8)

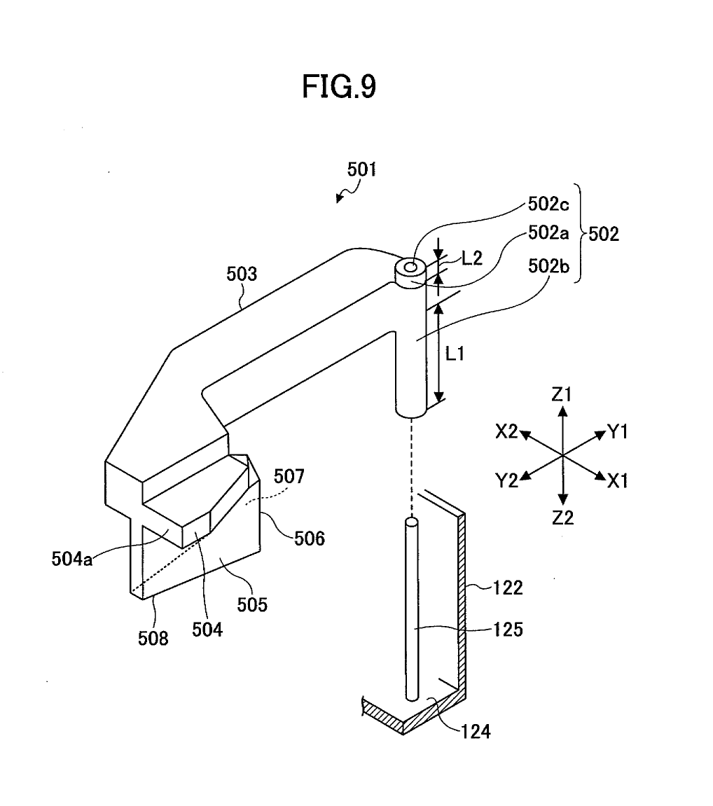

4. Tape Cartridge Misloading Prevention Mechanism 500 (FIGS. 9, 10, and 11)

5. Operations of Tape Cartridge Misloading Prevention Mechanism 500

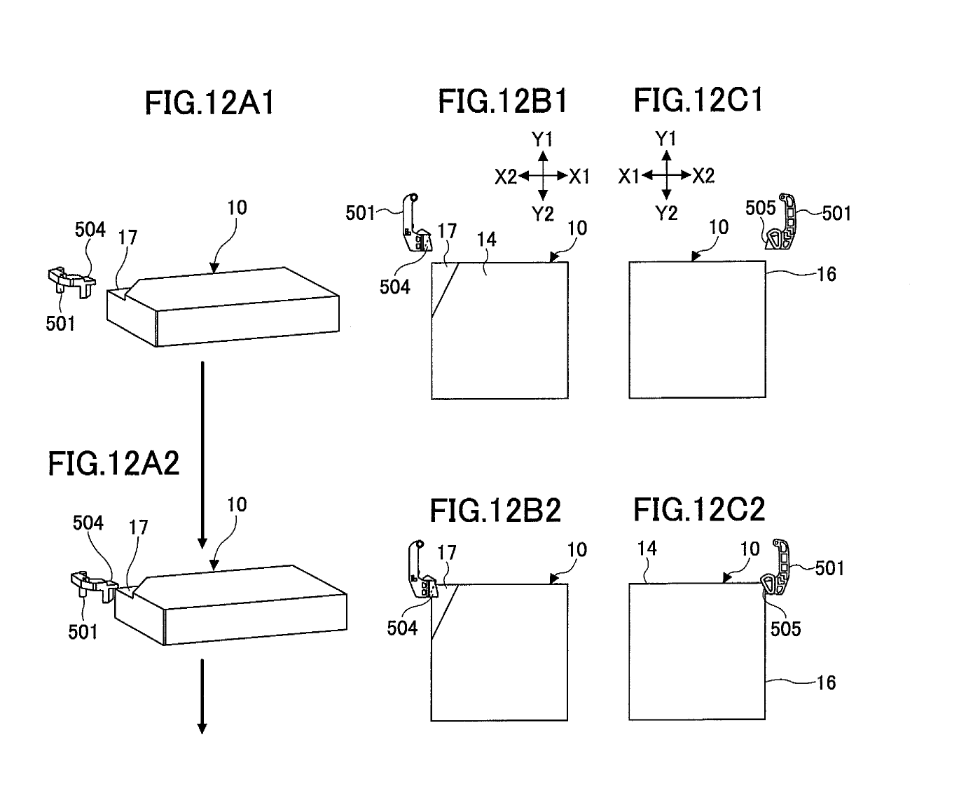

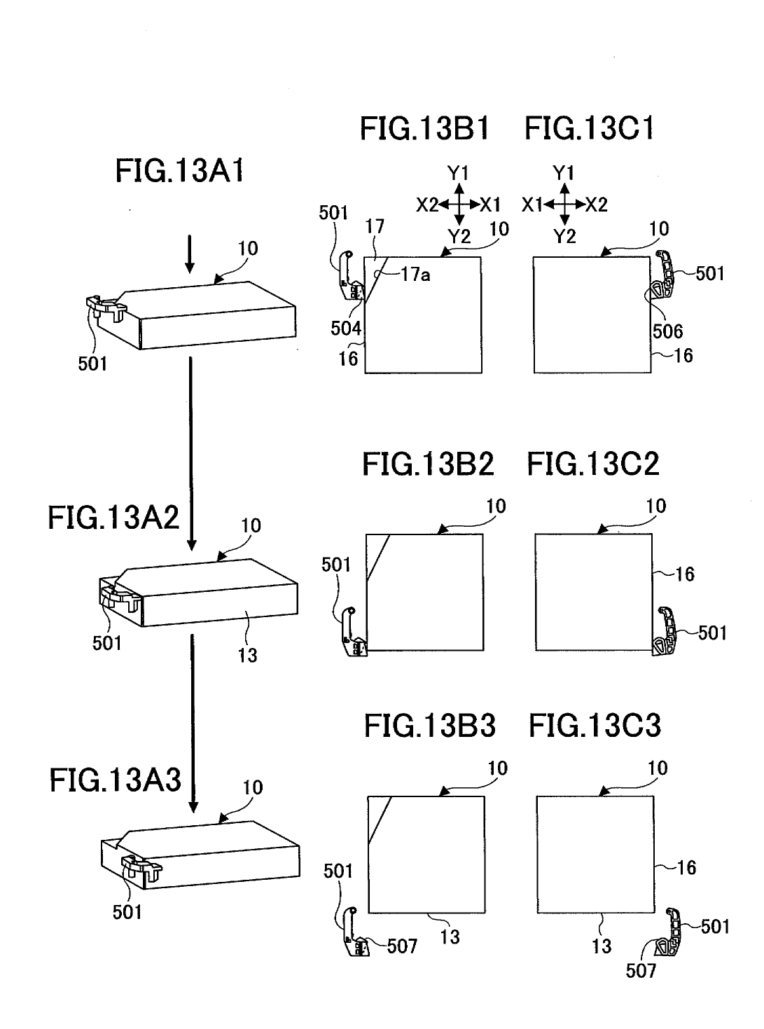

5-1. Case Where Tape Cartridge is Properly Inserted (FIGS. 12 and 13)

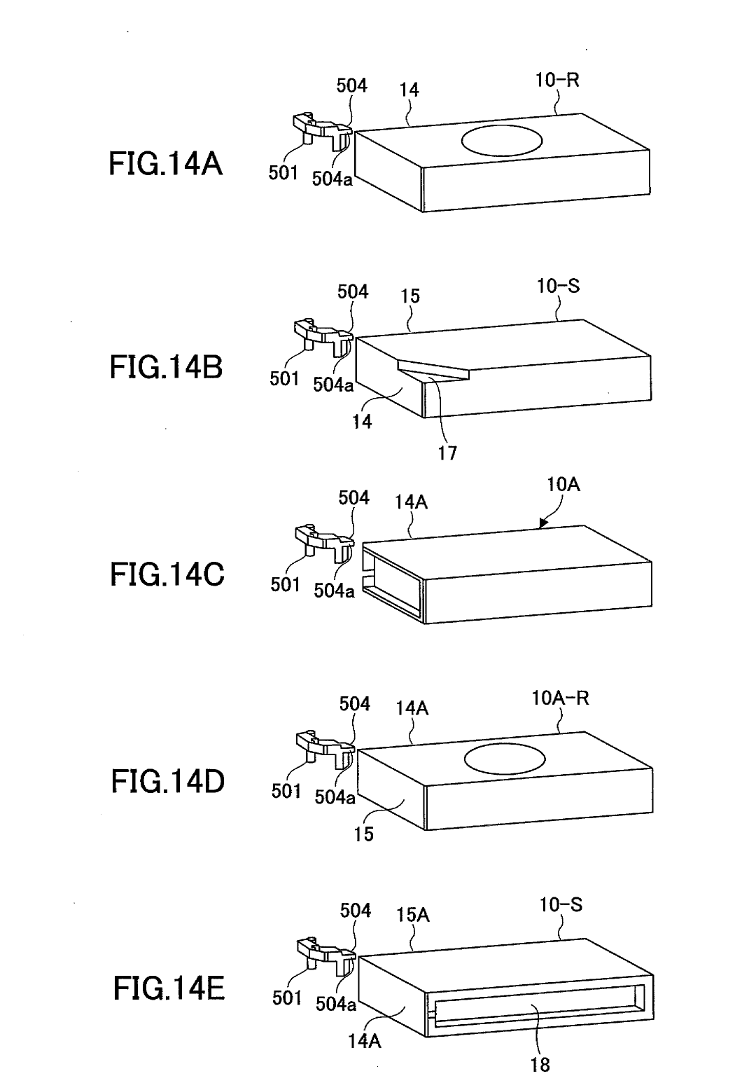

5-2. Other Cases (FIG. 14)

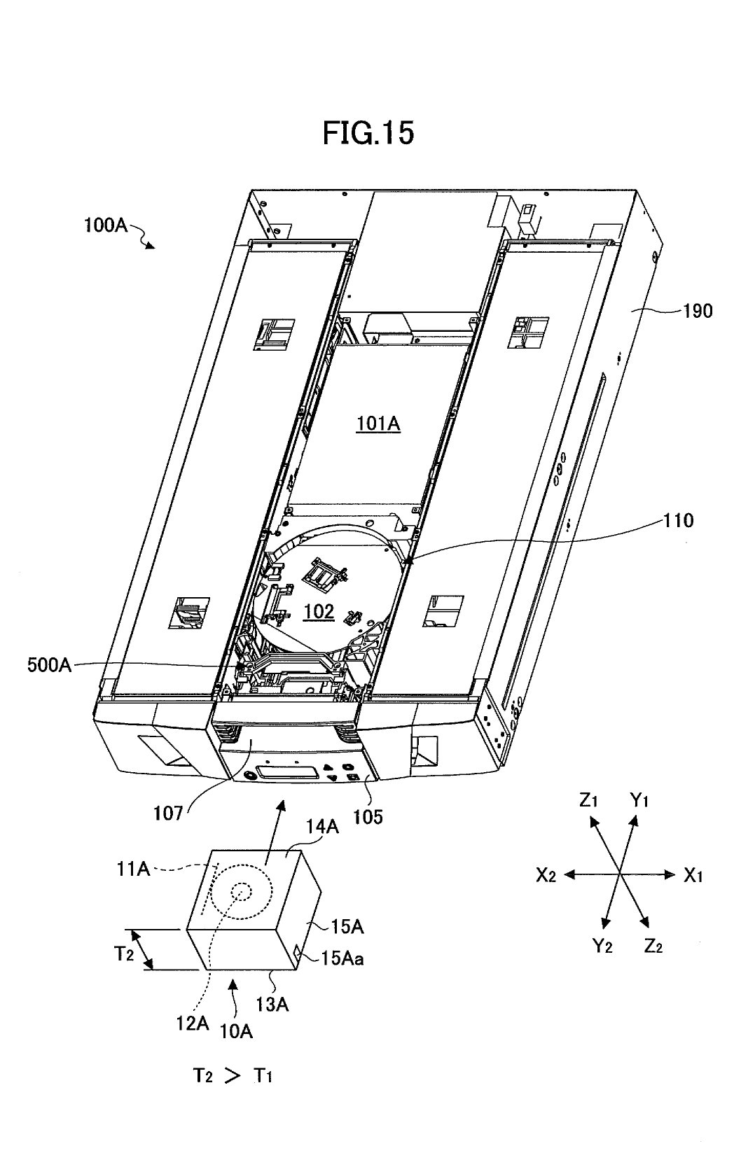

6. Configuration and Operations of DLT Tape Cartridge Autoloader 100A (FIG. 15)

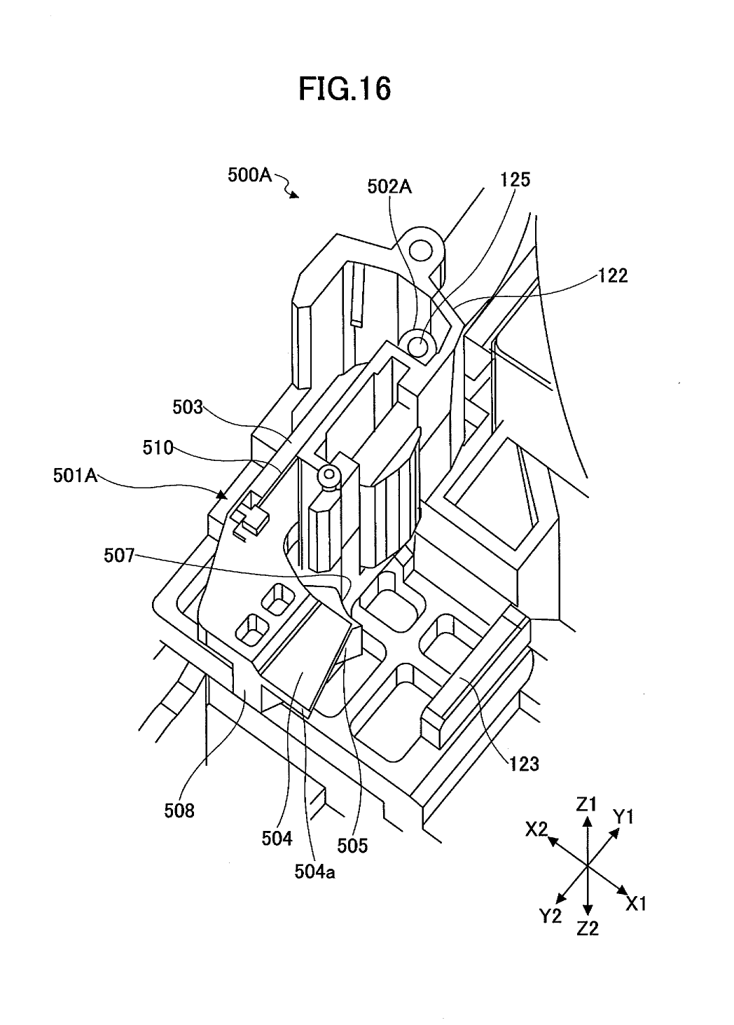

7. Tape Cartridge Misloading Prevention Mechanism 500A (FIGS. 16, 17, and 18)

8. Operations of Tape Cartridge Misloading Prevention Mechanism 500A

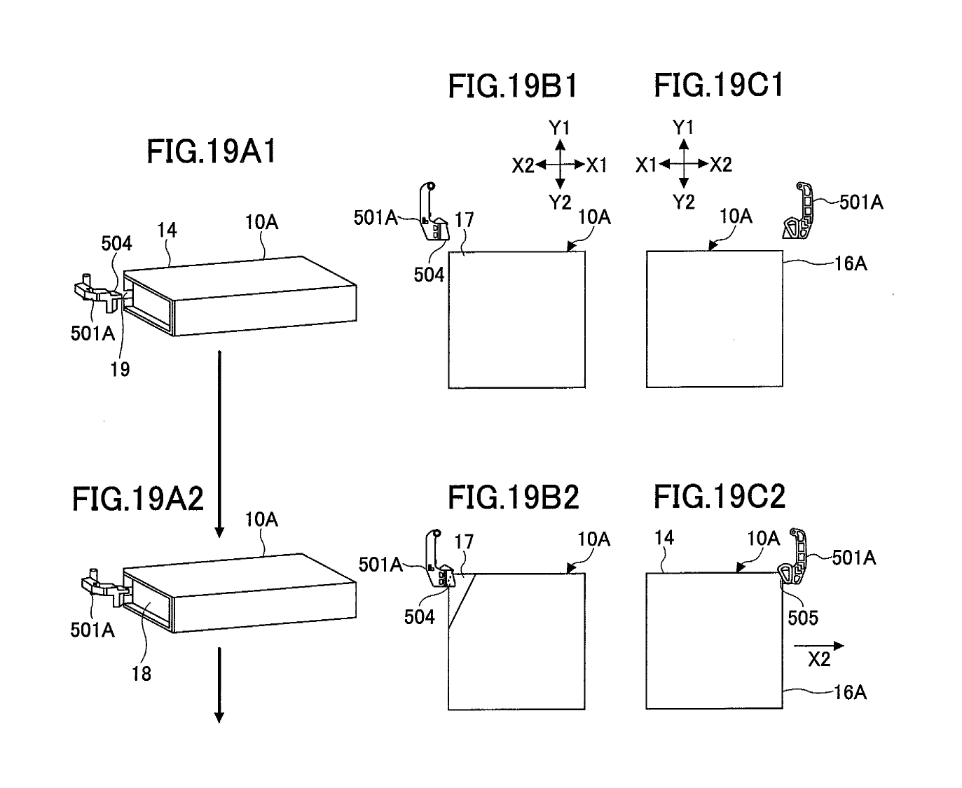

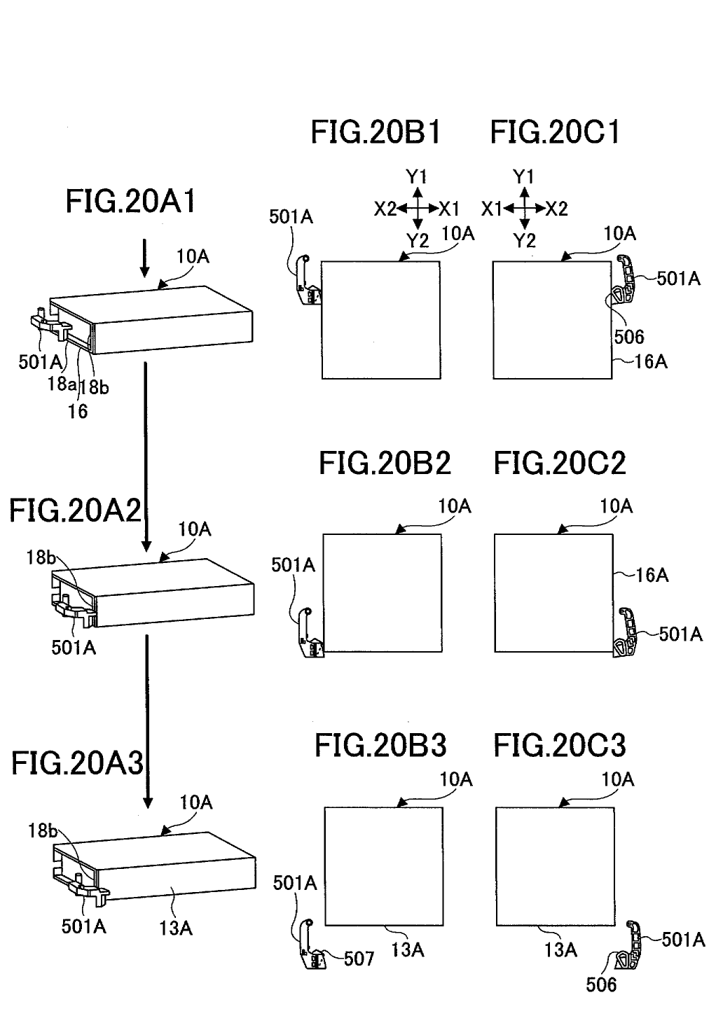

8-1. Case Where Tape Cartridge is Properly Inserted (FIGS. 19 and 20)

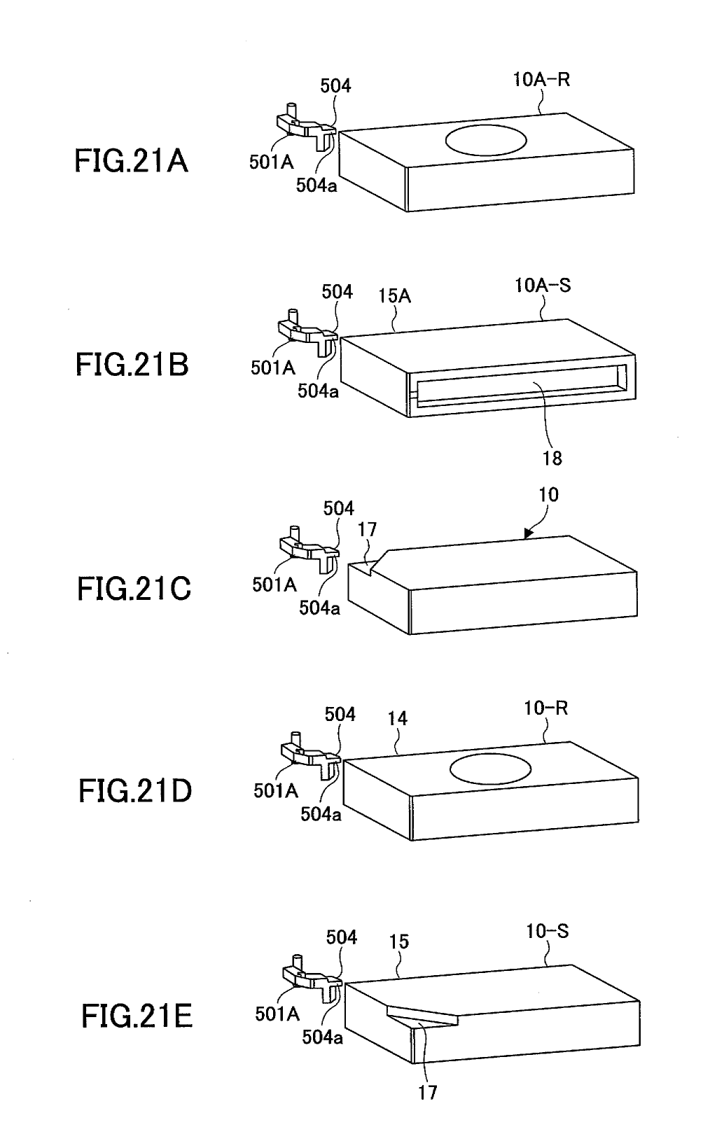

8-2. Other Cases (FIG. 21)

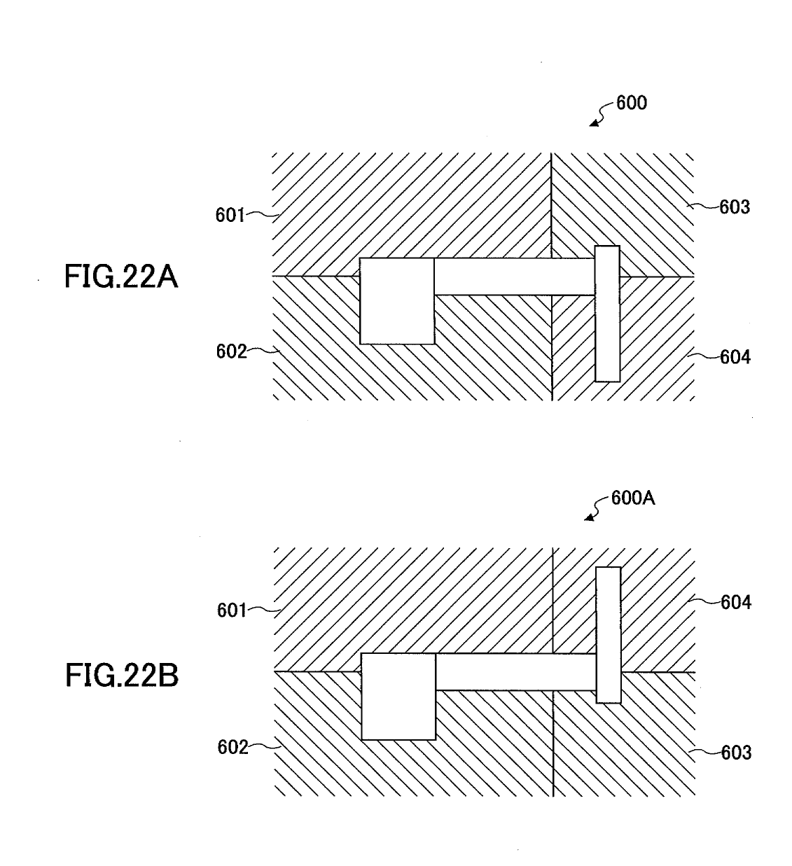

9. Method for Manufacturing Misloading Prevention Key 501 and Misloading Prevention Key 501A (FIG. 22)

1. [LTO Tape Cartridge 10 and DLT Tape Cartridge 10A Misloading Prevention in LTO Tape Cartridge Autoloader 100 and DLT Tape Cartridge Autoloader 100A] (FIG. 1)

In FIG. 1, a LTO tape cartridge autoloader 100, a DLT tape cartridge autoloader 100A, a LTO tape cartridge 10, and a DLT tape cartridge 10A are shown.

The LTO tape cartridge autoloader 100 includes a mail slot 107 as a loading slot at its front side, a tape cartridge picker 102 at the center, a LTO tape cartridge tape drive 101 at its rear portion, and a tape cartridge misleading prevention mechanism 500 arranged at the mail slot 107.

The DLT tape cartridge autoloader 100A includes a mail slot 107 at its front side, a tape cartridge picker 102 at the center, a DLT tape cartridge tape drive 101A at its rear portion, and a tape cartridge misleading prevention mechanism 500A arranged at the mail slot 107.

In FIG. 1, the LTO tape cartridge 10 in a proper position, a LTO tape cartridge 10-R positioned upside down, and a LTO tape cartridge 10-S facing the wrong direction are shown. Also the DLT tape cartridge 10A in a proper position, a DLT tape cartridge 10A-R positioned upside down, and a DLT tape cartridge 10A-S facing the wrong direction are shown.

In the LTO tape cartridge autoloader 100, the tape cartridge misloading prevention mechanism 500 is configured to enable the LTO tape cartridge 10 to pass through the mail slot 107 in the case where the LTO tape cartridge 10 is properly positioned upon being inserted into the mail slot 107. In other cases, namely, in cases where the LTO tape cartridge 10 is not properly positioned (e.g., LTO tape cartridges 10-R and 10-S), or in a case where the DLT tape cartridge 10A is inserted, the tape cartridge misleading prevention mechanism 500 is configured to reject the inserted tape cartridge. It is noted that in FIG. 1, the mark ◯ denotes acceptance of the inserted tape cartridge, and the mark × denotes rejection of the inserted tape cartridge.

In the DLT tape cartridge loader 100A, tape cartridge misloading prevention mechanism 500A is configured to enable the DLT tape cartridge 10A to pass through the mail slot 107 in the case where the DLT tape cartridge 10A is properly positioned upon being inserted into the mail slot 107. In other cases, namely, in cases where the DLT tape cartridge 10A is not properly positioned (e.g., DLT tape cartridges 10A-R and 10A-S), or in a case where the LTO tape cartridge 10 is inserted, the tape cartridge misloading prevention mechanism 500A is configured to reject the inserted tape cartridge.

2. [Configuration and Operations of LTO Tape Cartridge Autoloader 100] (FIGS. 2, 3, and 4)

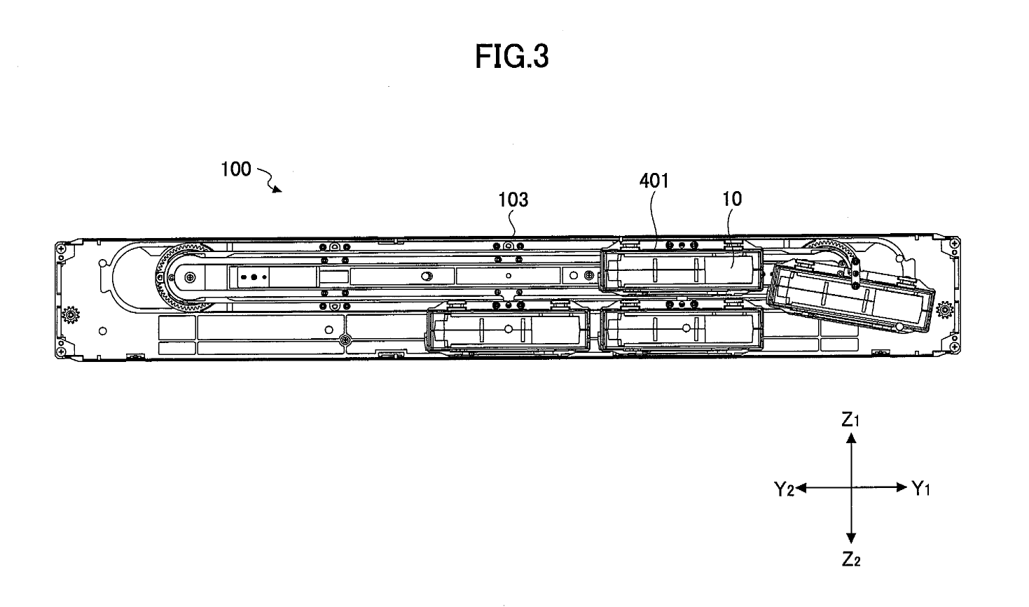

FIG. 2 is a diagram showing the LTO tape cartridge autoloader 100 according to a first embodiment of the present invention with its upper cover removed. FIG. 3 is a diagram showing a configuration of the LTO tape cartridge autoloader 100 with its side cover removed. It is noted that in these drawings, directions X1-X2 represent width direction, direction Y1-Y2 represent depth directions, and directions Z1-Z2 represent height directions.

In one embodiment, the LTO tape cartridge autoloader 100 generally comprises a metal frame 190, a control panel 105 and a mail slot 107 both arranged on a front panel, a main module 110 including a tape cartridge picker 102 at a position opposing the mail slot 107, a LTO tape cartridge read/write tape drive 101 disposed at the Y1 side of the main module 110, and one or more tape cartridge transport magazines 103 and 104 (for example, two tape cartridge transport magazines 103 and 104 are shown in the embodiment illustrated in FIG. 2), which in this embodiment, are disposed one at the X1 side and the X2 side of the main module 110. For example, the tape cartridge transport magazines 103 and 104 can be inserted toward the Y1 side from the front panel side and removably attached on opposing sides of the frame 190. In an alternative embodiment, the tape cartridge transport magazines 103, 104 can be positioned to have a different orientation relative to one another and/or to the main module 110. In one embodiment, the LTO tape cartridge autoloader 100 can be mounted in a rack by fixing four corners of the frame 190 to poles of the rack, for example.

As is shown in FIG. 3, the tape cartridge transport magazines 103 and 104 each have plural containers 401, and are configured to accommodate the LTO media cartridges 10 in the containers 401 with the front faces 13 facing toward the tape cartridge picker 102. The tape cartridge transport magazines 103 and 104 are also configured to transport the media cartridges 10 along a racetrack path elongated in the Y1-Y2 direction.

The LTO tape cartridge tape drive 101 is operable to read and/or write data from or to the magnetic tape 11 pulled out from the loaded LTO tape cartridge 10. The LTO tape cartridge tape drive 101 includes a tape cartridge eject mechanism (not shown).

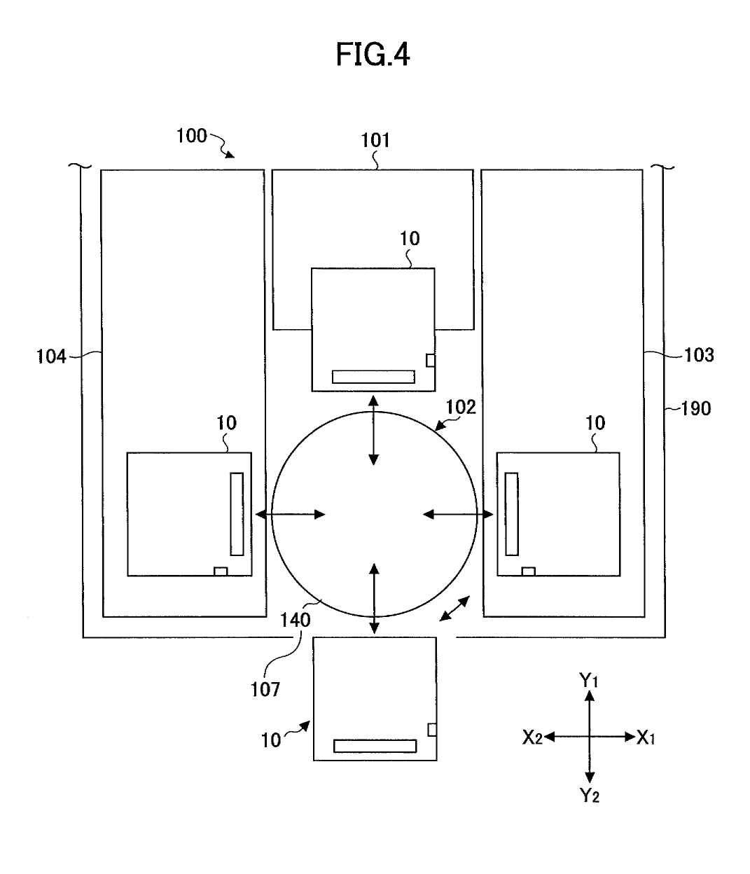

As is shown in FIG. 4, the tape cartridge picker 102 is configured to transport the LTO tape cartridge 10 onto or off of a turntable 140 for operations such as loading the LTO tape cartridge 10 inserted through the mail slot 107 into the LTO tape cartridge tape drive 101, retrieving the LTO tape cartridge 10 from the tape cartridge transport magazines 103 and 104 to load the LTO tape cartridge 10 onto the LTO tape cartridge tape drive 101r retrieving the LTO tape cartridge 10 from the LTO tape cartridge tape drive 101 to return the LTO tape cartridge 10 to the tape cartridge transport magazines 103 and 104, and ejecting the LTO tape cartridge 10 through the mail slot 107. The tape cartridge picker 102 is also configured to rotate the turntable 140 by a predetermined rotational interval, such as by approximately 90-degree increments, although the rotational interval can vary depending upon the design requirements of the LTO tape cartridge autoloader 100. The tape cartridge picker 102 can also lift/lower the turntable 140 as necessary. When the turntable 140 is rotated, the orientation of the LTO tape cartridge 10 is changed.

When an ejection command is issued, the LTO tape cartridge 10 is transported by a tape cartridge linear transporting mechanism 170 (described below) through the mail slot 107 until its front face 13 side protrudes out of the mail slot 107. Then, an operator may get hold of the LTO tape cartridge 10 and pull this LTO tape cartridge 10 out of the LTO tape cartridge autoloader 100.

3. [Configuration of Main Module 110] (FIGS. 5, 6, 7, and 8)

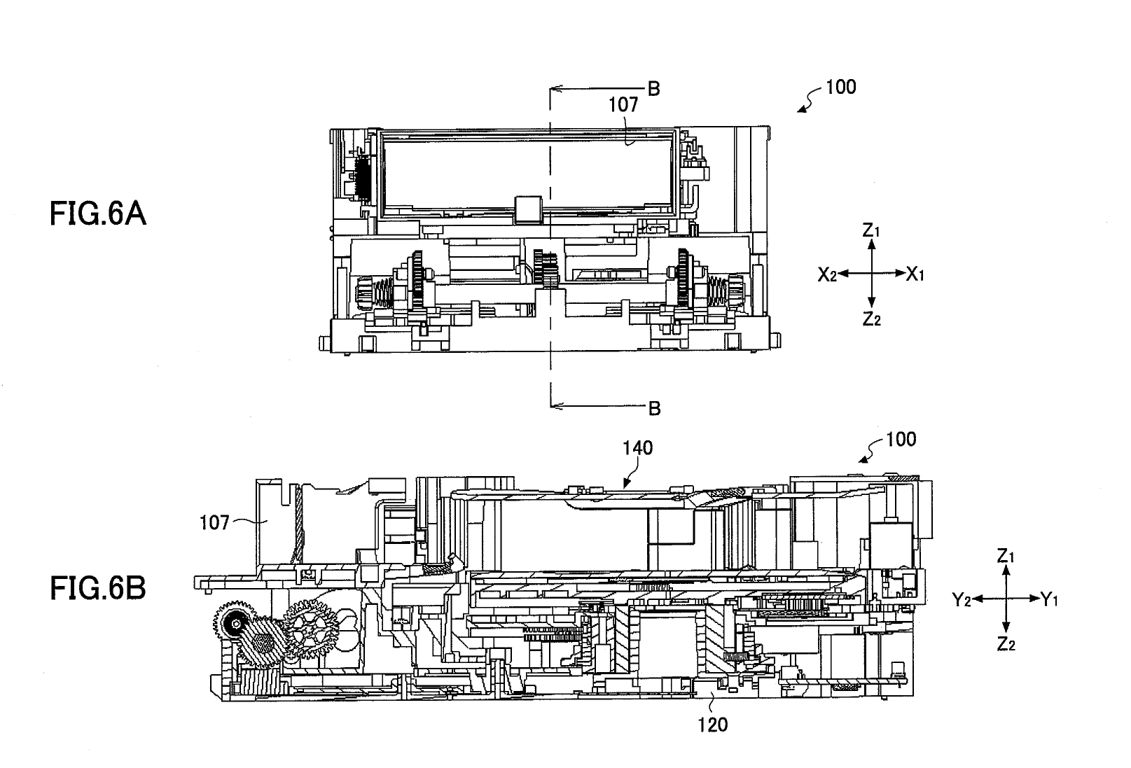

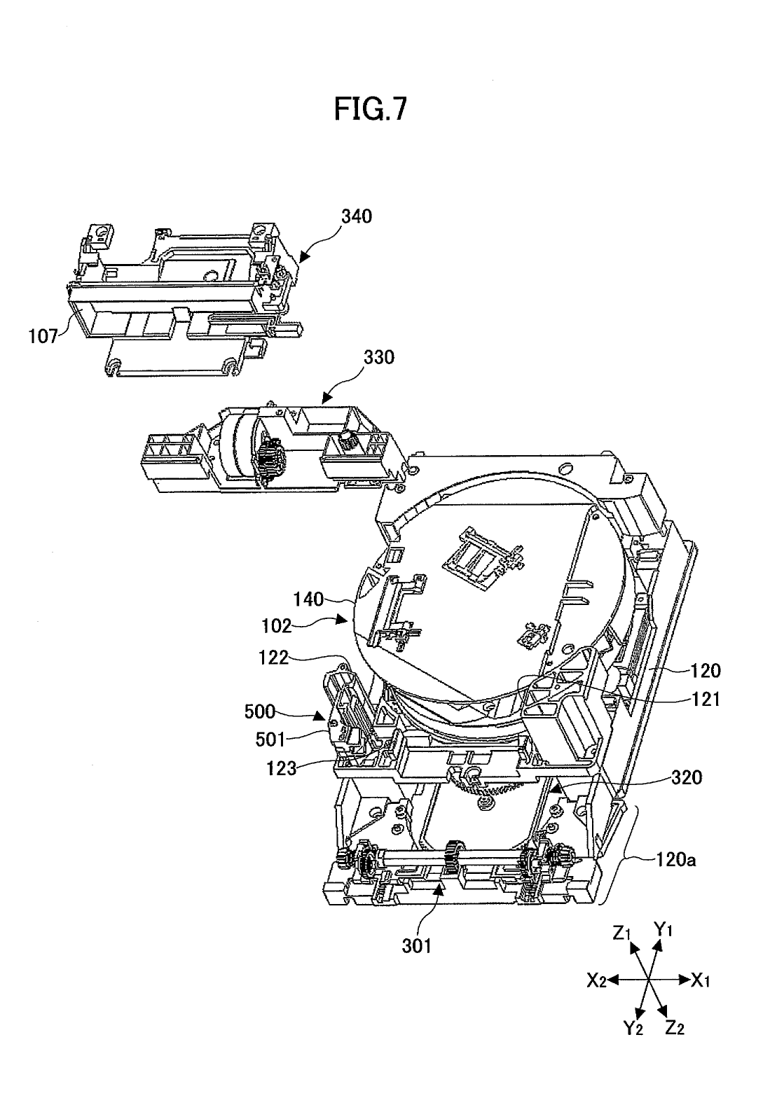

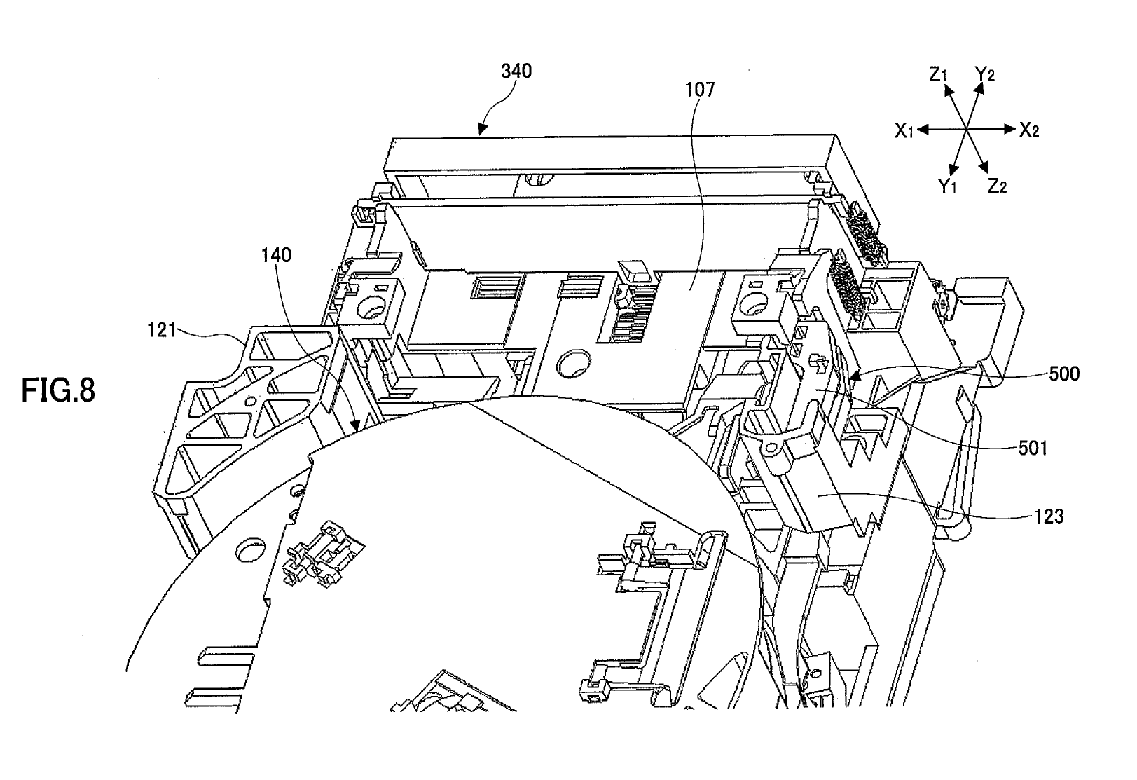

FIG. 5 is a perspective view of the main module 110; FIG. 6A is a front view of the main module 110; and FIG. 6B is a cross-sectional view of the main module 110. FIG. 7 is an exploded view of the main module 110. FIG. 8 is a perspective view of the main module 110, viewed from the Y1 side.

In this embodiment, the main module 110 includes a base 120. The main module 110 also includes the tape cartridge picker 102, a tape cartridge transport magazine drive motor module 330, a mail slot module 340, a rotation transmitting channel forming apparatus 300, and the tape cartridge misleading prevention mechanism 500. The mail slot module 340 includes a frame 341 and the mail slot 107 arranged inside the frame 341. The tape cartridge picker 102 can occupy a large part of the base 120. The base 120 includes an extension 120a extending at the Y2 side of the tape cartridge picker 102. A drive shaft unit 301 and a tape cartridge transport magazine drive motor module 330 are disposed on the extension 120a. For example, the mail slot module 340 can be mounted on the upper side of the magazine drive motor module 330. As is shown in FIGS. 6A and 6B, in one embodiment, the mail slot 107 may be disposed at the same height as the turntable 140.

The base 120 at the Y2 side of the tape cartridge picker 102 includes a tape cartridge guide hollow pillar 121 at the X1 side, a tape cartridge guide hollow pillar 122 at the X2 side, and a tape cartridge guide rail 123 at the Z2 side. The tape cartridge guide hollow pillars 121, 122, and the tape cartridge guide rail 123 are disposed along the outline of the mail slot 107 viewed from the Y2 side, and are configured to guide the LTO tape cartridge 10 that is being transported through the mail slot 107 and into the tape cartridge picker 102.

4. [Tape Cartridge Misloading Prevention Mechanism 500] (FIGS. 9, 10, and 11)

The tape cartridge misleading prevention mechanism 500 is arranged at the tape cartridge guide hollow pillar 122, and comprises a misleading prevention key 501 as is shown in FIG. 9. In one embodiment, the misleading prevention key 501 is supported within the tape cartridge guide hollow pillar 122 as is shown in FIGS. 5, 10, 11A, and 11B, and is applied a force in the counterclockwise direction by a spring 510.

As is shown in FIG. 9, the misleading prevention key 501 includes a center tube 502, an arm portion 503 extending from the center tube 502, a protruding plate 504 at the tip of the arm portion 503, and a triangular prism block 508. The protruding plate 504 includes an end face 504a at its Y2 side. The triangular prism block 508 includes a first slanted face 505, a second slanted face 507, and a corner portion 506. The corner portion 506 is formed by the first slanted face 505 and the second slanted face 507.

In the present embodiment, a stationary shaft 125 is arranged to extend from a bottom plate 124 to protrude in the Z1 direction within the tape cartridge guide hollow pillar 122.

The center tube 502 includes a portion 502a corresponding to the arm portion 503, a portion 502b having a length L1 that protrudes from the arm portion 503 in the Z2 direction, and a portion 502c having a length L2 that protrudes from the arm portion 503 in the Z1 direction. The length L2 is relatively short, and in one embodiment, the length L1 is arranged to be at least five times greater than the length L2. Alternatively, the length L1 can be less than or equal to five times greater than the length L2.

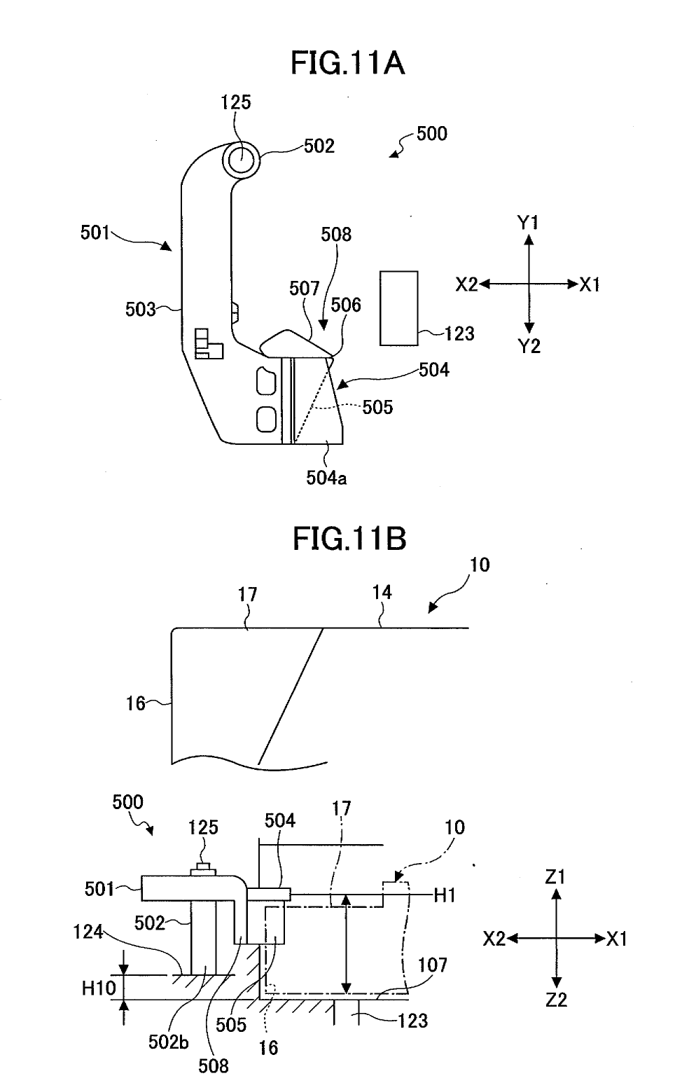

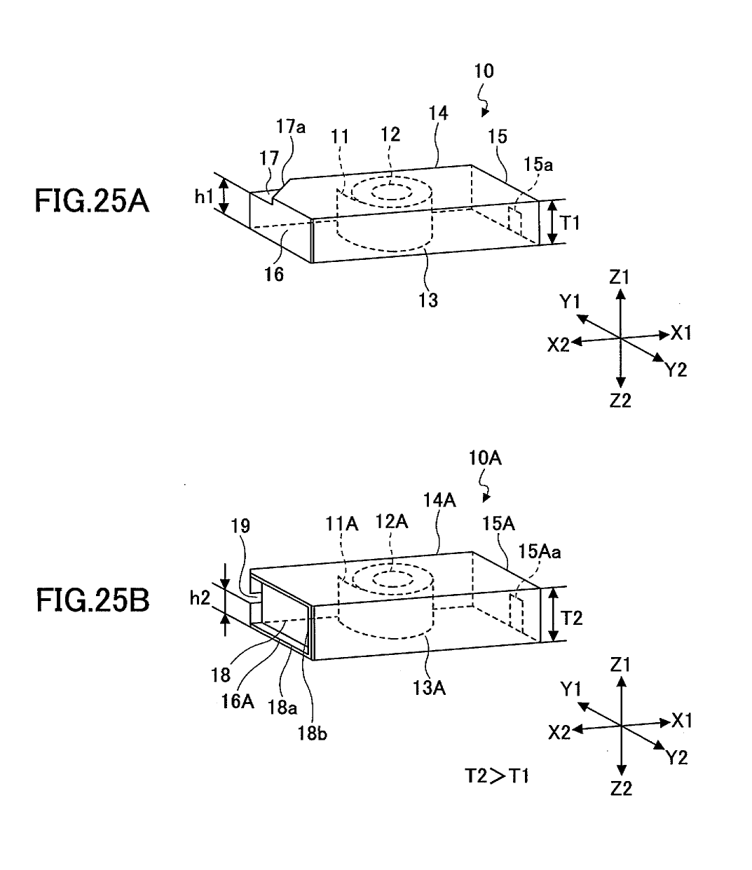

The misloading prevention key 501 is rotatably mounted by realizing engagement of the center tube 502 and the stationary shaft 125 arranged within the tape cartridge guide hollow pillar 122. In this case, the bottom end of the center tube 502 comes into contact with the bottom plate 124, and the protruding plate 504 is disposed at a height H1 from the top face of the tape cartridge guide rail 123 (see FIG. 11B). It is noted that in the present embodiment, the height H1 corresponds to the height h1 of the recessed step portion 17 from the bottom face of the LTO tape cartridge 10 shown in FIG. 25A.

The arm portion 503 is arranged to extend in the Y2 direction. The protruding plate 504 and the triangular prism block 508 are arranged to protrude into the mail slot 107 from the X2 side. In this case, the end face 504a of the protruding plate 504 is arranged to be perpendicular to the Y1-Y2 line; that is, the end face 504a is arranged to be perpendicular to the tape cartridge inserting direction.

As is shown in FIG. 11B, the triangular prism block 508 is disposed at the Z2 side of the protruding plate 504. As is shown in FIG. 11A, the first slanted face 505 extends from the end face 504a of the protruding plate 504 in a direction slightly slanted from the Y1 direction. The extending direction of the first slanted face 505 slants toward the X1 direction as it extends in the Y1 direction. The corner portion 506 is disposed at one end of the first slanted face 505, and is arranged to protrude in the X1 direction. Similarly, as is shown in FIG. 11A, the second slanted face 507 is disposed toward the Y2 side with respect to the protruding plate 504, and is arranged to extend in a direction slightly slanted toward the X1 direction from the Y2 direction.

The protruding plate 504 is configured such that its end face 504a blocks the inserting direction front end face of a tape cartridge that is erroneously inserted.

The first slanted face 505 and the corner portion 506 of the triangular block 508 are configured to be pushed by a tape cartridge that is properly inserted so that the protruding plate 504 may be displaced to a position where it may not obstruct the insertion of the tape cartridge.

The second slanted face 507 of the triangular prism block 508 is configured to be pushed by a tape cartridge that is being ejected so that the protruding plate 504 may be displaced to a position where it may not obstruct the ejection of the tape cartridge.

5. [Operations of Tape Cartridge Misloading Prevention Mechanism 500]

5-1. [Case Where Tape Cartridge is Properly Inserted] (FIGS. 12 and 13)

FIGS. 12 and 13 are diagrams illustrating a case in which the LTO tape cartridge 10 is inserted in a proper position with its rear face 14 facing forward in the inserting direction. It is noted that FIGS. 12A1, 12A2, and FIGS. 13A1-13A3 are perspective views of the LTO tape cartridge and the misleading prevention key 501. FIGS. 12B1, 12B2, and FIGS. 13B1-13B3 are corresponding plan views from the Z1 side; and FIGS. 12C1, 12C2, and FIGS. 13C1-13C3 are corresponding plan views from the Z2 side.

FIGS. 12A1, 12B1, and 12C1 are diagrams showing the LTO tape cartridge 10 being inserted into the mail slot 107 in the Y1 direction to face the misloading prevention key 501. Specifically, in these drawings, the recessed step portion 17 is facing the protruding plate 504.

When the LTO tape cartridge 10 is inserted further into the mail slot 107, the recessed step portion 17 engages the lower side of the protruding plate 504 as is shown in FIGS. 12A2 and 12B2. Also, in this case, the X2 side edge of the rear face 14 of the LTO tape cartridge 10 comes into contact with the first slanted face 505 of the triangular prism block 508 as is shown in FIG. 12C2.

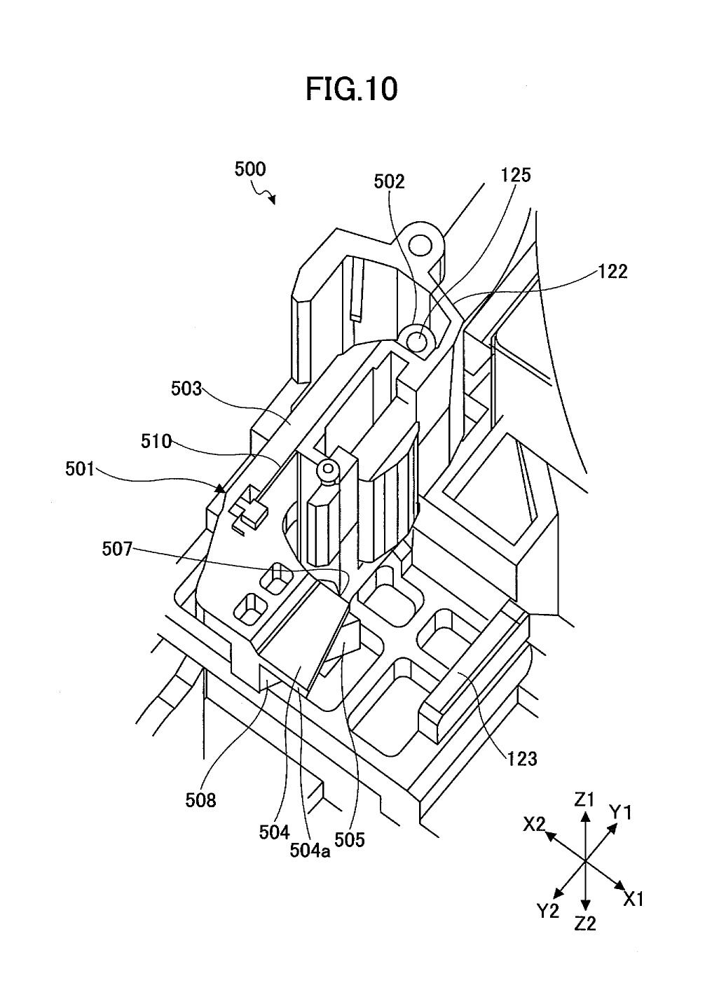

When the LTO tape cartridge 10 is inserted further into the mail slot 107, the first slanted face 505 is pushed in the X2 direction as is shown in FIGS. 13A1, 13B1, and 13C1. In this case, the side face 16 of the LTO tape cartridge 10 comes into contact with the corner portion 506 at the edge of the first slanted face 505, and the misleading prevention key 501 is rotated in the clockwise direction viewed from the Z1 side against the force of the spring 510 (illustrated in FIG. 10) as is shown in FIG. 13C1. Also, the protruding plate 504 is displaced toward the X2 direction to be positioned on the X2 side of the recessed step portion 17 as is shown in FIG. 13B1. In this way, the LTO tape cartridge 10 may be inserted through the mail slot 107 without hitting the protruding plate 504 as is shown in FIGS. 13A2, 13B2, and 13C2 to pass through the misleading prevention key 501 as is shown in FIGS. 13A3, 13B3, and 13C3.

As can be appreciated from the above descriptions, when the LTO tape cartridge 10 is inserted in a proper position and orientation, the LTO tape cartridge 10 may be inserted through the mail slot 107 without being blocked by the misloading prevention key 501 and pass the lateral side of the misloading prevention key 501.

After the LTO tape cartridge 10 passes the misleading prevention key 501, the misloading prevention key 501 is reverted to its original position by the force of the spring 510, and the second slanted face 507 of the triangular prism block 508 faces the front face 13 of the LTO tape cartridge 10. During ejection, the LTO tape cartridge 10 pushes the second slanted face 507 to displace the triangular prism block 508 in the X2 direction and is transported in the Y1 direction through the mail slot 107.

5-2. [Other Cases] (FIG. 14)

FIGS. 14A-E illustrate non-exclusive examples of cases other than that illustrated in FIGS. 12 and 13.

Specifically, FIG. 14A illustrates a case of inserting the LTO tape cartridge 10-R that is positioned upside down. In this case, the rear face 14 of the LTO tape cartridge 10-R hits the end face 504a of the protruding plate 504 so that the LTO tape cartridge 10-R is prevented from being inserted further into the mail slot 107.

FIG. 14B illustrates a case of inserting the LTO tape cartridge 10-S that is oriented such that its side face 15 corresponds to the inserting direction front end. In this case, the side face 15 of the LTO tape cartridge 10-S hits the protruding plate 504 so that the LTO tape cartridge 10-S is prevented from being inserted further into the mail slot 107.

The LTO tape cartridge 10-S is similarly prevented from being inserted through the mail slot 107 in a case where its side face 16 or its front face 13 corresponds to the inserting direction front end in which case the side face 16 or the front face 13 hits the protruding plate 504.

FIG. 14C illustrates a case of inserting the DLT tape cartridge 10A. In this case, since the slit 19 is positioned toward the Z2 side with respect to the protruding plate 504, the rear face 14A of the DLT tape cartridge 10A hits the protruding plate 504 so that the DLT tape cartridge 10A is prevented from being inserted further into the mail slot 107.

FIG. 14D illustrates a case of inserting the DLT tape cartridge 10A-R that is positioned upside down. In this case, the rear face 14A of the DLT tape cartridge 10A-R hits the protruding plate 504 so that the DLT tape cartridge 10A-R is prevented from being inserted further into the mail slot 107.

FIG. 14E illustrates a case of inserting the DLT tape cartridge 10A-S that is oriented such that its side face 15A corresponds to the inserting direction front end. In this case, the side face 15A of the DLT tape cartridge 10A-S hits the protruding plate 504 so that the DLT tape cartridge 10A-S is prevented from being inserted further into the mail slot 107.

The DLT tape cartridge 10A-S is similarly prevented from being inserted through the mail slot 107 in a case where its side face 16A or its front face 13A corresponds to the inserting direction front end in which case the side face 16A or the front face 13A hits the protruding plate 504.

As can be appreciated from the above descriptions, although the specific configuration of the misleading prevention key 501 can vary from those illustrated in the Figures, the misleading prevention key 501 can be configured to enable the LTO tape cartridge 10 to pass through the mail slot 107 only when the LTO tape cartridge 10 is inserted in the proper position and orientation, and thwart tape cartridge insertion in other cases.

6. [Configuration and Operations of DLT Tape Cartridge Autoloader 100A] (FIG. 15)

FIG. 15 is a diagram showing the DLT tape cartridge autoloader 100A according to a second embodiment of the present invention. The DLT tape cartridge autoloader 100A is adapted for the DLT tape cartridge 10A. Since the size of the DLT tape cartridge 10A is substantially the same as the size of the LTO tape cartridge 10, the DLT tape cartridge autoloader 100A is substantially identical to the LTO tape cartridge autoloader 100 except for its main module 110A.

The main module 110A includes a tape cartridge misleading prevention mechanism 500A that is different from the tape cartridge misleading prevention mechanism 500 of the main module 100. It is noted that other parts of the main module 110A are identical to those of the main module 100.

7. [Tape Cartridge Misloading Prevention Mechanism 500A] (FIGS. 16, 17, and 18)

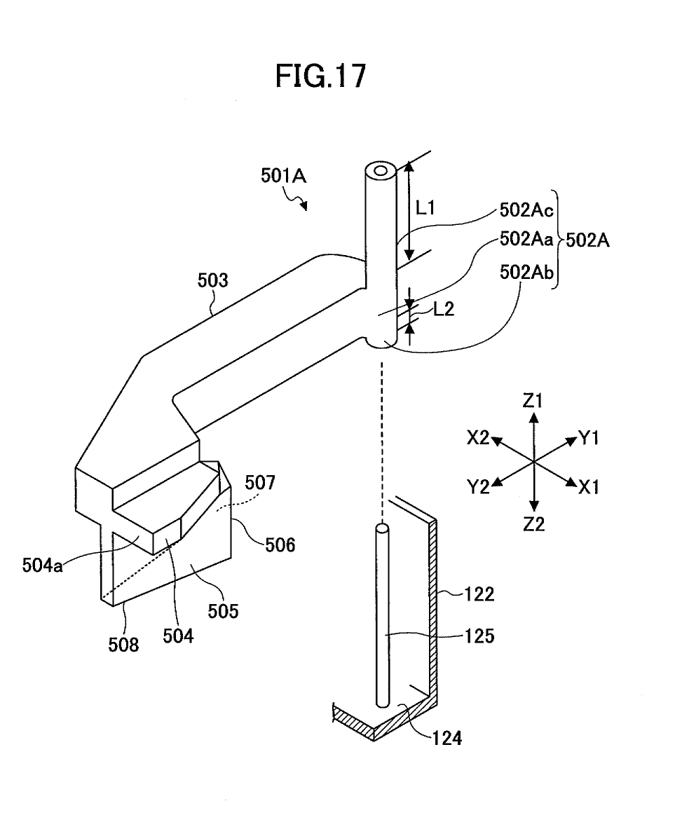

FIG. 16 is a diagram showing the tape cartridge misleading prevention mechanism 500A. The tape cartridge misleading prevention mechanism 500A is adapted for the DLT tape cartridge 10A, and includes a misloading prevention key 501A as is shown in FIG. 17.

The misleading prevention key 501A includes a center tube 502A that differs from the center tube 502 of the misleading prevention key 501. Other parts of the misleading prevention key 501A are identical to the misleading prevention key 501. Specifically, the misloading prevention key 501A includes the arm portion 503, the protruding plate 504, and the triangular prism block 508 as is described above.

The center tube 502A has a configuration that is reciprocal to the configuration of the center tube 102 of the misleading prevention key 501 with respect to the X-Y plane at the center of the arm portion 502. That is, in this embodiment, the center tube 502A includes a portion 502Ab protruding from the arm portion 503 in the Z2 direction that is arranged to have a relatively short length L2, and a portion 502Ac protruding from the arm portion 503 in the Z1 direction that has a length L1 that is substantially longer than the length L2.

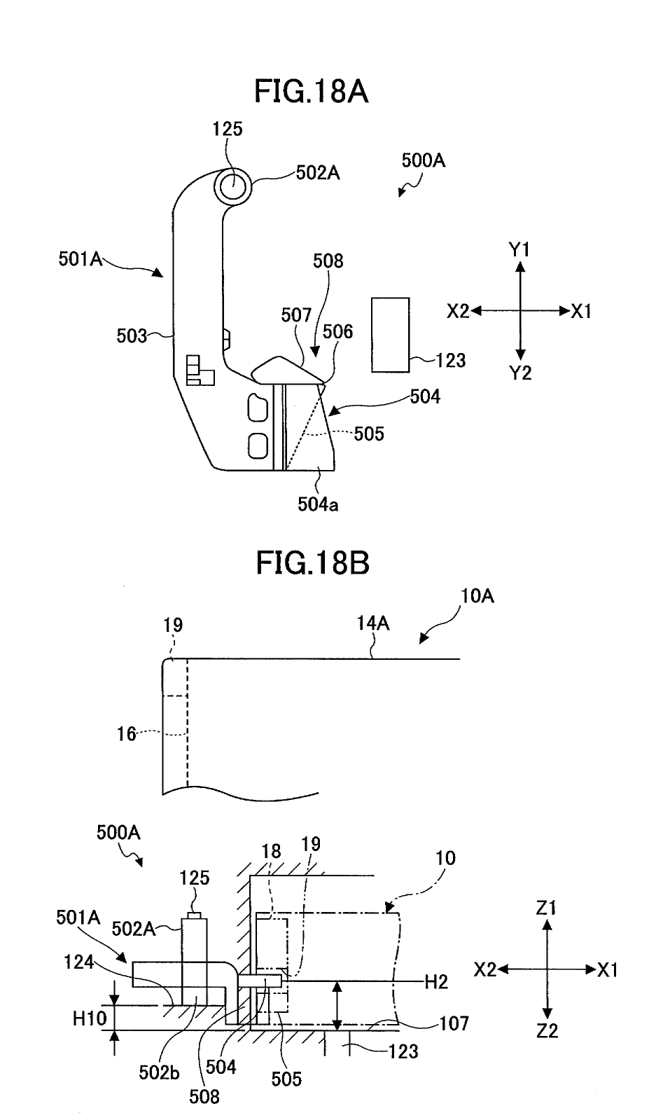

The misleading prevention key 501A is rotatably mounted by realizing engagement of the center tube 502A and the stationary shaft 125 arranged within the tape cartridge guide hollow pillar 122. In this case, the bottom end of the center tube 502A comes into contact with the bottom plate 124, and the protruding plate 504 is disposed at a height H2 from the top face of the tape cartridge guide rail 123 (see FIG. 18B). It is noted that in the present embodiment, the height H2 corresponds to the height h2 of the slit 19 from the bottom face of the DLT tape cartridge 10A shown in FIG. 25B.

As is shown in FIG. 18B, the height H10 of the bottom plate 124 of the base 120 with respect to the top face of the tape cartridge guide rail 123 is adjusted such that the protruding plate 504 may be positioned at the height H1 in a case where the misleading prevention key 501 is arranged at the tape cartridge guide hollow pillar 122, and the protruding plate 504 may be positioned at the height H2 in a case where the misloading prevention key 501A is arranged at the tape cartridge guide hollow pillar 122.

8. [Operations of Tape Cartridge Misloading Prevention Mechanism 500A]

8-1. [Case Where Tape Cartridge is Properly Inserted] (FIGS. 19 and 20)

FIGS. 19 and 20 are diagrams illustrating a case in which the DLT tape cartridge 10A is inserted in a proper position with its rear face 14A facing forward in the inserting direction. It is noted that FIGS. 19A1, 19A2, and FIGS. 20A1-20A3 are perspective views of the LTO tape cartridge and the misleading prevention key 501A. FIGS. 19B1, 19B2, and FIGS. 20B1-20B3 are corresponding plan views from the Z1 side; and FIGS. 19C1, 19C2, and FIGS. 20C1-20C3 are corresponding plan views from the Z2 side.

FIGS. 19A1, 19B1, and 19C1 are diagrams showing the LTO tape cartridge 10 being inserted into the mail slot 107 in the Y1 direction to face the misloading prevention key 501. Specifically, in these drawings, the slit 19 is facing the protruding plate 504.

When the DLT tape cartridge 10A is inserted further into the mail slot 107, the slit 19 engages the protruding plate 504 as is shown in FIGS. 19A2 and 19B2, and the protruding plate 504 passes through the slit 19 to enter the recessed portion 18 as is shown in FIGS. 20A1, 20B1, and 20C1.

Also, as is shown in FIG. 19C2, the X2 side edge of the rear face 14A of the DLT tape cartridge 10A comes into contact with the first slanted face 505 of the triangular prism block 508 so that the triangular prism block 508 is pushed in the X2 direction. When the DLT tape cartridge 10A is inserted further into the mail slot 107, the edge portion 18a of the side face 16A of the DLT tape cartridge 10A comes into contact with the corner portion 506, and misleading prevention key 501 is rotated in the clockwise direction viewed from the Z1 side against the force of the spring 510 (illustrated in FIG. 16) and retained in this position as is shown in FIG. 20C1. In this case, the protruding plate 504 is displaced toward the X2 direction to be positioned at the X2 side of the recessed portion 18 as is shown in FIG. 20B1.

When the DLT tape cartridge 10A is inserted further into the mail slot 107, the edge portion 18b closes in on the protruding plate 504. At this point, the edge portion 18a is still in contact with the corner portion 506 of the triangular prism block 508. Thus, the edge portion 18b passes the protruding plate 504 without hitting the end face 504a as is shown in FIGS. 20A2, 20B2, and 20C2. Further, the DLT tape cartridge 10A may be inserted past the misleading prevention key 501A as is shown in FIGS. 20A3, 20B3, and 20C3.

As can be appreciated from the above descriptions, when the DLT tape cartridge 10A is inserted in a proper position and orientation, the DLT tape cartridge 10A may be inserted through the mail slot 107 without being blocked by the misleading prevention key 501A and pass the lateral side of the misleading prevention key 501A.

After the DLT tape cartridge 10A passes the misleading prevention key 501A, the misleading prevention key 501A is reverted to its original position by the force of the spring 510, and the second slanted face 507 of the triangular prism block 508 faces the front face 13 of the DLT tape cartridge 10A. During ejection, the DLT tape cartridge 10 pushes the second slanted face 507 to displace the triangular prism block 508 in the X2 direction and is transported in the Y1 direction through the mail slot 107.

8-2. [Other Cases] (FIG. 21)

FIGS. 21A-E illustrate non-exclusive embodiments of cases other than that illustrated in FIGS. 19 and 20.

Specifically, FIG. 21A illustrates a case of inserting the DLT tape cartridge 10A-R that is positioned upside down. In this case, the rear face 14A of the DLT tape cartridge 10A-R hits the end face 504a of the protruding plate 504 so that the DLT tape cartridge 10A-R is prevented from being inserted further into the mail slot 107.

FIG. 21B illustrates a case of inserting the DLT tape cartridge 10A-S that is oriented such that its side face 15A corresponds to the inserting direction front end. In this case, the side face 15A of the DLT tape cartridge 10A-S hits the protruding plate 504 so that the DLT tape cartridge 10A-S is prevented from being inserted further into the mail slot 107.

The DLT tape cartridge 10A-S is similarly prevented from being inserted through the mail slot 107 in a case where its side face 16A or its front face 13A corresponds to the inserting direction front end in which case the side face 16A or the front face 13A hits the protruding plate 504.

FIG. 21C illustrates a case of inserting the LTO tape cartridge 10. In this case, since the triangular recessed step portion 17 is positioned toward the Z1 side with respect to the protruding plate 504, the rear face 14 of the LTO tape cartridge 10 hits the protruding plate 504 so that the LTO tape cartridge 10 is prevented from being inserted further into the mail slot 107.

FIG. 21D illustrates a case of inserting the LTO tape cartridge 10-R that is positioned upside down. In this case, the rear face 14 of the LTO tape cartridge 10-R hits the protruding plate 504 so that the LTO tape cartridge 10-R is prevented from being inserted further into the mail slot 107.

FIG. 21E illustrates a case of inserting the DLT tape cartridge 10-S that is oriented such that its side face 15 corresponds to the inserting direction front end. In this case, the side face 15 of the LTO tape cartridge 10-S hits the protruding plate 504 so that the LTO tape cartridge 10-S is prevented from being inserted further into the mail slot 107.

The LTO tape cartridge 10-S is similarly prevented from being inserted through the mail slot 107 in a case where its side face 16 or its front face 13 corresponds to the inserting direction front end in which case the side face 16 or the front face 13 hits the protruding plate 504.

As can be appreciated from the above descriptions, although the specific configuration of the misloading prevention key 501A can vary from those illustrated in the Figures, the misleading prevention key 501A can be configured to enable the DLT tape cartridge 10A to pass through the mail slot 107 only when the DLT tape cartridge 10 is inserted in the proper position and orientation, and thwart tape cartridge insertion in other cases.

9. Method for Manufacturing Misloading Prevention Key 501 and Misloading Prevention Key 501A (FIG. 22)

FIG. 22A is a diagram showing a mold apparatus 600 for molding the misleading prevention key 501. The mold apparatus 600 includes upper and lower molds 601 and 602 for molding the parts of the misloading prevention key 501 other than the center tube 502 (i.e., the arm portion 503, the protruding plate 504, and the first and second slanted faces 505 and 507) and upper and lower molds 603 and 604 for molding the center tube 502. The misleading prevention key 501 is molded using this mold apparatus 600.

FIG. 22B is a diagram showing a mold apparatus 600A for molding the misloading prevention key 501A. The mold apparatus 600A includes components identical to those of the mold apparatus 600 but has the mold 603 and the mold 604 arranged at reverse positions with respect to their positions within the mold apparatus 600.

As can be appreciated from the above descriptions, the misleading prevention key 501 and the misleading prevention key 501A may be molded using the same molds so that manufacturing costs may be reduced compared to a case in which molds dedicated for each of the misleading prevention keys 501 and 501A are used.

It is noted that a tape cartridge misleading prevention mechanism according to an embodiment of the present invention is not limited to application within a tape cartridge autoloader as is described above, and may also be used in other applications such as a tape cartridge library.

Although the present invention is shown and described with respect to certain non-exclusive embodiments, it is obvious that equivalents and modifications may occur to others skilled in the art upon reading and understanding the specification. The present invention includes all such equivalents and modifications, and is limited only by the scope of the appended claims.

The present application is based on and claims the benefit of the earlier filing date of Japanese Patent Application No. 2006-198417 filed on Jul. 20, 2006, the entire contents of which are hereby incorporated by reference.

What is claimed is:

1. A tape cartridge recording/playback apparatus comprising:
an inlet through which a tape cartridge is passed; and
an interior portion into which the tape cartridge is inserted, the interior portion being configured to accommodate a plurality of the tape cartridges and including a tape cartridge misleading prevention key for preventing misleading of the tape cartridge, the tape cartridge misleading key being rotatably mounted at a location close to the inlet; wherein
the tape cartridge misleading prevention key includes a protruding portion that is configured to block an inserting direction front end face of the tape cartridge when the tape cartridge is improperly inserted and prevent the tape cartridge from being inserted further, and a block portion that is configured to be pushed by the tape cartridge when the tape cartridge is properly inserted and displace the protruding portion to a position where the protruding portion does not block insertion of the tape cartridge.

2. The tape cartridge recording/playback apparatus as claimed in claim 1, wherein
the block portion includes a first slanted face portion that configured to be pushed by the tape cartridge that is properly inserted and displace the protruding portion to the position where the protruding portion does not block insertion of the tape cartridge, and a second slanted face portion that is configured to be pushed by the tape cartridge when the tape cartridge is being ejected and displace the protruding portion to a position where the protruding portion does not block ejection of the tape cartridge.

3. The tape cartridge recording/playback apparatus as claimed in claim 1, wherein
the tape cartridge misleading prevention key includes an arm portion having a tip portion at which the protruding portion and the block portion are arranged, and a center tube portion arranged at a base portion side of the arm portion; and
the tape cartridge misleading prevention key is mounted by engaging the center tube with a stationary shaft of the tape cartridge recording/playback apparatus.

4. The tape cartridge recording/playback apparatus as claimed in claim 3, wherein
a positional relationship between the stationary shaft and the inlet is arranged such that either one of two different types of the tape cartridge misleading prevention keys having the center tubes extending in different directions from the arm portions can be mounted, the tape cartridge recording/playback apparatus being adapted for a first type of the tape cartridge or a second type of the tape cartridge depending on the type of the tape cartridge misleading prevention key that is being mounted.

5. A tape cartridge recording/playback apparatus that receives a tape cartridge into an interior portion of the apparatus, the apparatus comprising:
a tape cartridge misleading prevention key that prevents misleading of the tape cartridge, the tape cartridge misleading key being rotatably mounted in the interior portion, the tape cartridge misleading prevention key including (i) a protruding portion that blocks an inserting direction front end face of the tape cartridge when the tape cartridge is improperly inserted and inhibits the tape cartridge from being inserted further, the protruding portion being in a first plane, and (ii) a block portion that is contacted by the tape cartridge when the tape cartridge is properly inserted, the block portion moving the protruding portion to a position where the protruding portion does not block insertion of the tape cartridge, the block portion being in a second plane that is different than the first plane.

6. A tape cartridge recording/playback apparatus that receives a tape cartridge into an interior portion of the apparatus, the apparatus comprising:
a tape cartridge misleading prevention key that prevents misleading of the tape cartridge, the tape cartridge misleading key being rotatably mounted in the interior portion, the tape cartridge misleading prevention key including (i) a protruding portion that blocks an inserting direction front end face of the tape cartridge when the tape cartridge is improperly inserted and inhibits the tape cartridge from being inserted further, and (ii) a block portion that is disposed at a different height from the protruding portion, that block portion being contacted by the tape cartridge when the tape cartridge is properly inserted, the block portion moving the protruding portion to a position where the protruding portion does not block insertion of the tape cartridge.
